(19) United States
(12) Patent Application Publication
(10) Pub. No.: US 2023/0382261 A1
(43) Pub. Date: Nov. 30, 2023

(54) SYSTEM AND METHOD FOR VEHICLE-SIDE CONTROL OF A MULTI-PILE CHARGING SESSION

(71) Applicant: MINE MOBILITY RESEARCH CO., LTD., Bangkok (TH)

(72) Inventors: Somphote AHUNAI, Bangkok (TH); Wen WU PAN, Shenzhen (CN); Gang LIU, Shenzhen (CN); Xiao Meng DENG, Shenzhen (CN); Hang Hang CHENG, Shenzhen (CN); Jian Hua LI, Shenzhen (CN); Xian Kai LUO, Shenzhen (CN); SI Yuan ZHANG, Shenzhen (CN)

(73) Assignee: MINE MOBILITY RESEARCH CO., LTD., Bangkok (TH)

(21) Appl. No.: 18/026,318

(22) PCT Filed: Sep. 27, 2021
(86) PCT No.: PCT/TH2021/000057

§ 371 Date: Mar. 14, 2023

(30) Foreign Application Priority Data
Sep. 28, 2020 (TH) 2001005629

(51) Int. Cl. B60L 53/67; B60L 53/16; B60L 53/18; B60L 53/66; B60L 53/68

(52) U.S. Cl. CPC B60L 53/67; B60L 53/16; B60L 53/18; B60L 53/66; B60L 53/68; B60L 2200/32; B60L 2250/00

(57) ABSTRACT

A system or method for vehicle-side control of a multi-pile charging session, the system comprising: (a) a plurality of charging piles (10A), each charging pile (10A) including a supply equipment communication controller (10B); and (b) a vehicle electrical system for an electric vehicle with a master battery control unit (18) in data communication with a plurality of battery control units (BCU₀, BCU₁, BCU₂). The master battery control unit (18) is configured to coordinate two or more independent charging sessions through the battery control units (BCU₀, BCU₁, BCU₂) during each multi-pile charging session. Each independent charging session is managed with an independent protocol message exchange through a BCU-to-SECC communication pathway (22) established by power line communication.

### TECHNICAL CONTRIBUTION

The present disclosure relates to electric vehicle charging. More particularly, the present disclosure relates to vehicle-side control of a multi-pile charging session comprising independent charging sessions.

### BACKGROUND

Charging piles of a charging substation are used for the controlled transfer of electrical power to electrical vehicles during charging sessions. Charging piles can be used in a commercial setting, wherein customers use the charging pile to charge their electric vehicle at a charging facility hosting one or more charging substations. To effect billing and authorization of each charging session, the charging piles are often in data communication with a server through a network. The server typically includes a database including vehicle records for the customers and meter records documenting each charging session performed by the charging piles. During the initiation stage of the charging session, a vehicle identifier for the electric vehicle is typically sent to the server. In the shutdown stage of the charging session, the final power delivery totals are stored in the meter records of the server's database. The server is thereafter accessed by the vendor to conduct customer billing procedures for charging sessions.

Charging ports on the electric vehicles are connected to charging connectors of the charging pile, often through an umbilical line spanning the distance therebetween. Industry standards typically dictate: (i) dimensions of the charging connectors and charging ports; (ii) voltage ranges for the charging piles; and (iii) current ranges for the charging piles. Widely implemented industry standards for the charging piles and initiation of separate charging sessions are included within ISO 15118/DIN 70121 and the national standard GB/T27930-2015. Charging piles following these standards can be used for many types of electric vehicles (typically passenger cars, buses, ferries, trolleys, and trains).

Use of a single charging pile may be sufficient for the charging session of a passenger car. But larger electric vehicles such as buses, ferries, trolleys, and trains require significant power transfer to their on-board battery which cannot be supplied in a reasonable time by a single charging pile. Each charging pile has by itself a limited power transfer rate (related to its maximum voltage and current range), therefore larger electric vehicles are often charged simultaneously from multiple charging piles housed in a charging substation. These charging sessions simultaneously using multiple charging piles are often called dual-gun charging sessions, multiple-gun charging sessions, or multi-pile charging sessions.

An example publication for multi-pile charging sessions is Chinese Patent Application No. CN109760545A, dated 17 May 2019 and entitled “Charging Method and Charging Device”. This publication describes the use of multiple charging piles of a charging substation to simultaneously charge an electric vehicle in a multi-pile charging session. One of the charging piles of the charging substation is designated the master charging pile. The master charging pile of the charging substation controls both its own charging session and the charging sessions of the other charging piles (designated “slave” charging piles) of the same charging substation. Hence, coordination of the separate charging sessions for each of the charging piles of the charging substation is performed by the master charging pile of the charging substation. While CN109760545A presents a method to coordinate the multi-pile charging session, it requires both a hardware modification (e.g., dedicated communication lines between each of the charging piles of the charging substation) and a software modification to the standardized communication protocols (e.g., to override the need for specific protocol messaging between the electric vehicle and the slave charging pile through the slave charging port).

This need for dedicated hardware communication links and software driven coordination between charging piles of a charging substation in the prior art can lead to compatibility issues. As a first matter, issues with incompatibility between legacy charging piles and newly acquired charging piles in the same charging substation are likely to arise over time, even if equipment initially purchased for the charging substation was fully functional at the time of initial set up. For instance, the newly purchased equipment may be a different model number or purchased from a different manufacturer entirely.

As a second matter, in the event of malfunction of one charging pile, the operation of other charging piles may also be affected due to communication error signals. For instance, faults detected during initiation of the charging piles of the charging substation could halt the entire multi-pile charging session.

As a third matter, a large charging facility may support multiple charging substations operated by different vendors. These multiple charging substations may be unconnected to each other. The master/slave protocols of the prior art assumes that the master charging pile and the slave charging pile are operated by the same vendor (and hence only require a single authorization from the vendor routed through the master charging pile). Thus, an electric vehicle would be unable to perform a multi-pile charging session using charging piles selected from the charging substations of multiple vendors located at the same charging facility.

What is needed therefore is a system and method for conducting multi-pile charging sessions with charging piles operating under the unmodified standardized communication protocols such that there is no need for either: (i) a set of dedicated communication lines between each of the charging piles; or (ii) any software driven coordination between the charging piles of the charging substation.

### SUMMARY

In its most general form, the invention is a system or method for vehicle-side control of a multi-pile charging session, the system comprising: (a) a plurality of charging piles, each charging pile including a supply equipment communication controller (SECC); and (b) a vehicle electrical system for an electric vehicle with a master battery control unit (MBCU) in data communication with a plurality of battery control units (BCU). The MBCU is configured to coordinate two or more independent charging sessions through the BCUs during each multi-pile charging session. Each independent charging session is managed with an independent protocol message exchange through a BCU-to-SECC communication pathway.

In more detail, a first embodiment of the invention is a system for vehicle-side control of a multi-pile charging session, the system comprising: (a) a plurality of charging piles; and (b) a vehicle electrical system for an electric vehicle. Each charging pile comprises: (i) a power line electrically connected to a power connector at a first end and to a charging connector at a second end; and (ii) a supply equipment communication controller (SECC). The power line is connectable to a utility line. The power line includes a relay switch positioned between the power connector and the charging connector. A charging pile power line communication module (CP-PLC) is positioned adjacent the power line between the relay switch and the charging connector. The SECC is in data communication with the relay switch and the CP-PLC. Current is permitted to flow from the utility line to the charging connector through the power line, upon activation of the relay switch by the SECC. The vehicle electrical system includes: (i) a battery including a plurality of battery management units (BMUs) and a plurality of battery cells; (ii) a busbar relay in electrical connection to the battery cells via at least one busbar battery trunk; (iii) a plurality of charging ports; (iv) a plurality of busbar input trunks; and (v) a master battery control unit (MBCU). Each charging port is configured for electrical connection to the charging connector of one of the charging piles. The charging port is directly electrically connected to the charging connector or the charging port is indirectly electrically connected to the charging connector through an umbilical line. Each busbar input trunk is electrically connected to one of the charging ports at a first junction and to the busbar relay at a second junction. Each busbar input trunk is in data communication with an electric vehicle power line communication module (EV-PLC) positioned adjacent the busbar input trunk between the charging port associated with the busbar input trunk and the busbar relay. The MBCU is in data communication with a plurality of battery control units (BCU), the BMUs of the battery, the busbar relay, and a user interface device. Each BCU is paired in data communication with one of the EV-PLCs to establish a BCU-to-SECC communication pathway for the BCU upon a connective pairing of the charging port associated with the BCU and one of the charging connectors. The BCU-to-SECC communication pathway for each BCU passes from the BCU to the EV-PLC associated with the BCU, to the busbar input trunk associated with the EV-PLC, to the connectively paired charging port associated with the busbar input trunk, to the connectively paired charging connector associated with the connectively paired charging port, to the power line associated with the connectively paired charging connector, to the CP-PLC associated with the power line, and to the SECC associated with the CP-PLC. The MBCU is configured to: (a) coordinate two or more independent charging sessions during each multi-pile charging session to charge the battery cells simultaneously through two or more charging ports according to a multi-pile charging plan; and (b) manage each independent charging session with an independent protocol message exchange through each BCU-to-SECC communication pathway, from the BCU of the BCU-to-SECC communication pathway to the SECC of the BCU-to-SECC communication pathway. Each independent charging session includes an initiation stage, a charging stage, and a shutdown stage conducted through the associated BCU-to-SECC communication pathway.

A second embodiment of the invention is a computer-implemented method for vehicle-side control of a multi-pile charging session, the method comprising the steps of: (a) maintaining a plurality of charging piles; (b) maintaining a vehicle electrical system for an electric vehicle; (c) coordinating with the MBCU two or more independent charging sessions during each multi-pile charging session to charge the battery cells simultaneously through two or more charging ports according to a multi-pile charging plan; and (d) managing with the MBCU each independent charging session with an independent protocol message exchange through each BCU-to-SECC communication pathway, from the BCU of the BCU-to-SECC communication pathway to the SECC of the BCU-to-SECC communication pathway, wherein each independent charging session includes an initiation stage, a charging stage, and a shutdown stage conducted through the associated BCU-to-SECC communication pathway. Each charging pile includes: (i) a power line electrically connected to a power connector at a first end and to a charging connector at a second end; and (ii) a supply equipment communication controller (SECC). The power line is connectable to a utility line. The power line includes a relay switch positioned between the power connector and the charging connector. A charging pile power line communication module (CP-PLC) is positioned adjacent the power line between the relay switch and the charging connector. The SECC is in data communication with the relay switch and the CP-PLC. Current is permitted to flow from the utility line to the charging connector through the power line, upon activation of the relay switch by the SECC. The vehicle electrical system includes: (i) a battery including a plurality of battery management units (BMUs) and a plurality of battery cells; and (ii) a busbar relay in electrical connection to the battery cells via at least one busbar battery trunk; (iii) a plurality of charging ports; (iv) a plurality of busbar input trunks; and (v) a master battery control unit (MBCU). Each charging port is configured for electrical connection to the charging connector of one of the charging piles. The charging port is directly electrically connected to the charging connector or the charging port is indirectly electrically connected to the charging connector through an umbilical line. Each busbar input trunk is electrically connected to one of the charging ports at a first junction and to the busbar relay at a second junction. Each busbar input trunk is in data communication with an electric vehicle power line communication module (EV-PLC) positioned adjacent the busbar input trunk between the charging port associated with the busbar input trunk and the busbar relay. The MBCU is in data communication with a plurality of battery control units (BCU), the BMUs of the battery, the busbar relay, and a user interface device. Each BCU is paired in data communication with one of the EV-PLCs to establish a BCU-to-SECC communication pathway for the BCU upon a connective pairing of the charging port associated with the BCU and one of the charging connectors. The BCU-to-SECC communication pathway for each BCU passes from the BCU to the EV-PLC associated with the BCU, to the busbar input trunk associated with the EV-PLC, to the connectively paired charging port associated with the busbar input trunk, to the connectively paired charging connector associated with the connectively paired charging port, to the power line associated with the connectively paired charging connector, to the CP-PLC associated with the power line, and to the SECC associated with the CP-PLC.

In an alternate embodiment of the first and second embodiment with a server, the embodiment further includes or maintains a server in data communication with the SECC of each charging pile through a network, the server including a database comprising a plurality of vehicle records and a plurality of meter records. Each vehicle record includes, for each of a plurality of vehicles, a vehicle identifier and an account status. Each meter record identifies at least one vehicle identifier and a charging session summary for each multi-pile charging session.

Technical objects of the invention include: (a) coordination of independent charging sessions of a multi-pile charging sessions without need of a dedicated communication line between each of the charging piles of the charging substation; and (b) coordination of independent charging sessions of a multi-pile charging sessions without need of specialized software protocols in the charging substation enabling master/slave coordination during multi-pile charging sessions. Hence, the invention enables multi-pile charging sessions using standard infrastructure (e.g., independent charging sessions conducted by the charging piles of a charging substations that have not be modified to enable coordination of multi-pile charging sessions using hardware and software modifications diverging from the industry standard).

The invention overcomes the need for compatibility between legacy charging piles and newly acquired charging piles installed on the same charging substation. The invention only requires the basic compliance of the charging piles with the industry standards. No communication or coordination between the charging piles is required within the charging substation. Charging piles purchased from different vendors or a mixture of charging pile model numbers will not affect the performance of the invention.

The invention is also better able to overcome malfunctions of one of the charging piles of a charging substation. The invention separately initializes the BCU-to-SECC communication pathway of each independent charging session using an independent protocol message exchange. This approach reduces the interdependencies between the charging piles. Each charging pile of the charging substation is only required to maintain minimum compliance with the industry standard. If one charging pile of a charging substation malfunctions and cannot comply with the industry standard, then another charging pile from the charging substation (or even another charging substation) can be swapped in to replace the malfunctioning charging pile.

The invention also supports multi-pile charging sessions using charging piles from different charging substations. For instance, with the invention, a first independent charging session of a multi-pile charging session can be initialized from a first vendor through a first customer account hosted by a first server through a first charging pile of a first charging substation. A second independent charging session of a multi-pile charging session can be initialized from a second vendor through a second customer account (for the same customer) hosted by a second server through a second charging pile of a second charging substation.

Hence, the invention represents and improvement over the prior art by: (a) reducing the impact of incompatibility issues between legacy charging piles and newly acquired charging piles; (b) reducing the impact of a malfunction of one of the charging piles of charging substation upon a multi-pile charging session; and (c) enabling use of charging piles from separate charging sub-stations of a charging facility, even where those charging sub-stations are managed by different vendors.

### BRIEF DESCRIPTION OF THE DRAWINGS

Embodiments of the present disclosure are described herein with reference to the drawings in which:

FIG. 1 is a block diagram representing the system in an embodiment of the invention.

FIG. 2 is a simplified block diagram representing the system in an embodiment of the invention with focus on the BCU-to-SECC communication pathway.

FIG. 3 is a simplified block diagram representing the system in an embodiment of the invention with focus on the electrical power transfer pathways between a charging pile and an electric vehicle.

FIG. 4 is a flowchart of steps taken in an embodiment of the invention.

### DETAILED DESCRIPTION

In the following detailed description, reference is made to the accompanying drawings, which form a part hereof. The illustrative embodiments described in the detailed description, drawings and claims are not meant to be limiting. Other embodiments can be utilized, and other changes can be made, without departing from the spirit or scope of the subject matter presented herein. Unless specified otherwise, the terms “comprising,” “comprise,” “including” and “include” used herein, and grammatical variants thereof, are intended to represent “open” or “inclusive” language such that they include recited elements but also permit inclusion of additional, un-recited elements.

As used herein, the software and hardware of a “server” may be implemented within: a single stand-alone computer, a stand-alone server, multiple dedicated servers, and/or a virtual server running on a larger network of servers and/or a cloud-based service. As used herein, a “database” may store data to and access data from a single stand-alone computer, a data server, multiple dedicated data servers, a cloud-based service, and/or a virtual server running on a network of servers.

As used herein, a “user interface device” may be implemented by a display monitor, a keyboard, a mouse, a touch screen, a touch pad, and/or a computing device including a processor and software. The user interface device may be configured as a laptop, a smart phone, a tablet, a single stand-alone computer, or a customized user interaction device of a vehicle control unit.

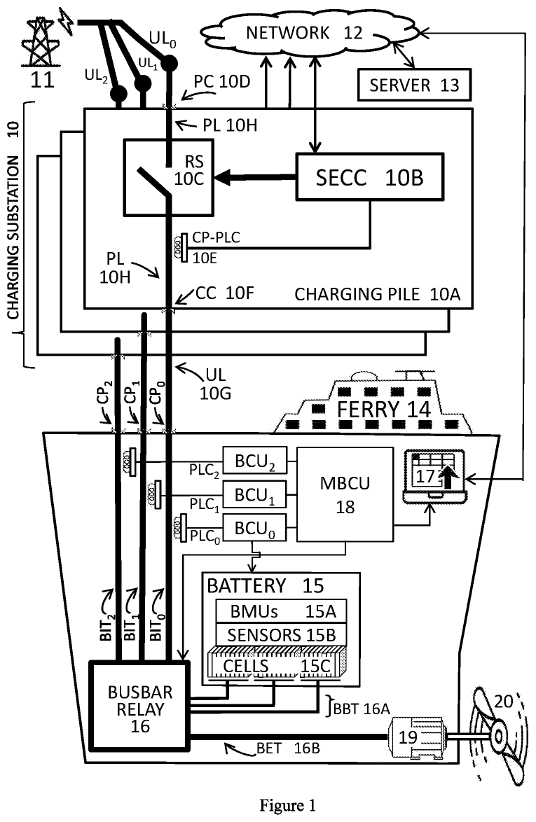

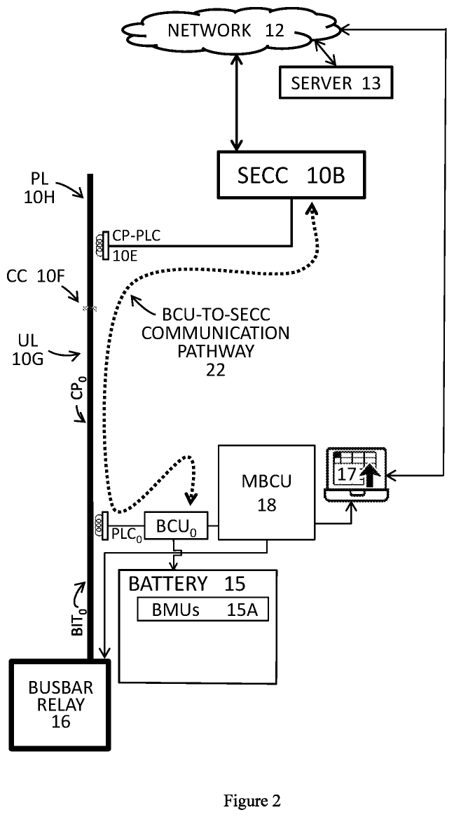

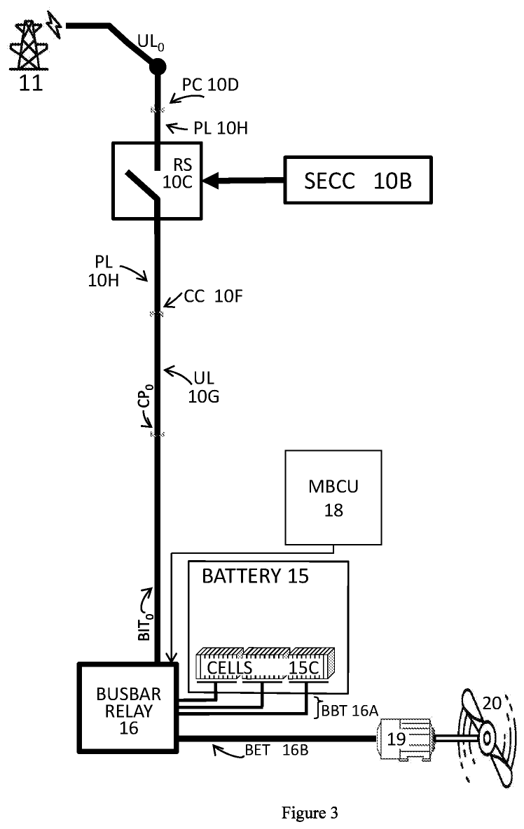

FIG. 1 is a block diagram representing the system in an embodiment of the invention comprising a server 13, a network 12, a plurality of charging piles 10A, and a ferry 14. Details of FIG. 1 focused on the data communication of this same system are depicted in FIG. 2. Details of FIG. 1 focused on the pathway of current from a utility provider 11 to the battery cells 15C are depicted in FIG. 3.

Note that while FIG. 1 depicts use of the invention with a ferry 14, the invention is applicable to any type of electrical vehicle benefiting from a multi-pile charging session. E.g., the invention can also be used for buses, trolleys, and trains.

As depicted in FIG. 1, a charging substation includes three charging piles 10A. Each charging pile 10A (represented in FIG. 1 as the topmost represented charging pile 10A) includes a power line 10H connected to a power connector 10D at a first end and a charging connector 10F at a second end. Between the power connector 10D and the charging connector 10F, the power line 10H includes a relay switch 10C controlled by a supply equipment communication controller (SECC) 10B. Each power connector 10D is connected electrically to a utility line (UL₀, UL₁, UL₂), which are connected to the utility provider 11. The SECC 10B is in data communication with a server 13 through a network 12. The SECC 10B is also in data communication with the power line 10H through a charging pile power line communication module (hereafter “CP-PLC”) 10E. While FIG. 1 depicts three charging piles 10A in the charging substation 10, the invention can use two or more charging piles 10A for each multi-pile charging session; these charging piles 10A can be located within the same charging sub-station 10 or in separate charging substations 10.

As depicted in FIG. 1 and FIG. 3 the electric vehicle of the invention is a ferry 14 with an electric motor 19 powering a ship propeller 20. The electric motor 19 is powered by the battery cells 15C of a battery 15, with a current passing: (i) from the battery cells 15C to a busbar relay 16 through a busbar battery trunk 16A; and (ii) from the busbar relay 16 to the electric motor 19 through a busbar engine trunk 16B. Charging current from a power line 10H of each charging pile 10A of the charging substation 10 passes into the ferry 14 from charging connector 10F of the charging pile 10A to the charging port (CP₀, CP₁, CP₂) of ferry 14 through an umbilical line 10G. The battery 15 includes a plurality of battery management units (BMUs) 15A, a plurality of battery sensors 15B, and the battery cells 15C. The busbar relay 16 is in electrical communication with three busbar relay trunks (BIT₀, BIT₁, BIT₂) connected at a first junction with the charging ports (CP₀, CP₁, CP₂) and to the busbar relay 16 at a second junction. Each busbar input trunk (BIT₀, BIT₁, BIT₂) is paired in data communication with a battery control unit (hereafter “BCU”, identified in FIGS. 1-2 as BCU₀, BCU₁, and BCU₂) through an electric vehicle power line communication module (hereafter “EV-PLC”, identified in FIGS. 1-2 as PLC₀, PLC₁, PLC₂). A master battery control unit (MBCU) 18 is in data communication with the BMUs 15A and a plurality of battery control units. The MCBU 18 can be configured to be in data communication with the BMUs 15A via at least one BCU (illustrated in FIGS. 1 and 2 as BCU₀). While not illustrated in FIGS. 1 and 2, the BMUs 15A can collect sensor information from the battery sensors 15B; the battery sensors 15B can be configured to monitor current, temperature, and other parameters of the battery cells 15C.

As most simply depicted in FIG. 2, each of the three illustrated BCUs (BCU₀, BCU₁, BCU₂) is paired in data communication with one of the EV-PLCs (PLC₀, PLC₁, and PLC₃) to establish a BCU-to-SECC communication pathway 22 for the BCU (BCU₀, BCU₁, BCU₂) upon a connective pairing of the charging port (CP₀, CP₁, CP₂) associated with the BCU (BCU₀, BCU₁, BCU₂) and one of the charging connectors 10F. The BCU-to-SECC communication pathway 22 for each BCU (BCU₀, BCU₁, BCU₂) passes from the BCU (BCU₀, BCU₁, BCU₂) to the EV-PLC (PLC₀, PLC₁, PLC₂) associated with the BCU (BCU₀, BCU₁, BCU₂), to the busbar input trunk (BIT₀, BIT₁, BIT₂) associated with the EV-PLC (PLC₀, PLC₁, PLC₂), to the connectively paired charging port (CP₀, CP₁, CP₂) associated with the busbar input trunk (BIT₀, BIT₁, BIT₂), to the connectively paired charging connector 10F associated with the connectively paired charging port (CP₀, CP₁, CP₂), to the power line 10H associated with the connectively paired charging connector 10F, to the CP-PLC 10E associated with the power line 10H, and to the SECC 10B associated with the CP-PLC 10E. The SECC 10B also conducts communication with the server 13 through the network 12. Note that the MBCU 18, which controls each BCU (BCU₀, BCU₁, BCU₂), is in data communication with the BMUs 15A via at least one BCU (illustrated in FIGS. 1 and 2 as BCU₀), the busbar relay 16, and the user interface device 17. While FIG. 1 depicts three sets of BCU-to-SECC communication pathways 22, the invention can be implemented with two or more.

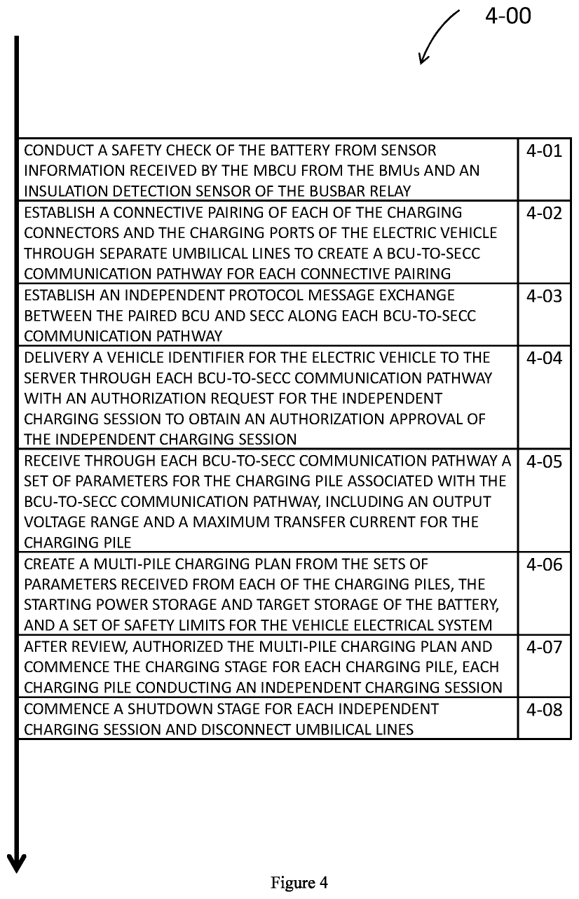

FIG. 4 is a flowchart 4-00 of steps taken in an embodiment of the invention. Steps 4-01 to 4-08 are listed below.
4-01 conduct a safety check of the battery 15 from sensor information received by the MBCU 18 from the BMUs 15A and an insulation detection sensor of the busbar relay 16
4-02 establish a connective pairing of each of the charging connectors 10F and the charging ports (CP₀, CP₁, CP₂) of the electric vehicle through separate umbilical lines 10G to create one BCU-to-SECC communication pathway 22 for each connective pairing
4-03 establish an independent protocol message exchange between the paired BCU (BCU₀, BCU₁, BCU₂) and SECC 10B along each BCU-to-SECC communication pathway 22
4-04 delivery a vehicle identifier for the electric vehicle to the server 13 through each BCU-to-SECC communication pathway 22 with an authorization request for the independent charging session to obtain an authorization approval of the independent charging session
4-05 receive through each BCU-to-SECC communication pathway 22 a set of parameters for the charging pile 10A associated with the BCU-to-SECC communication pathway 22, including an output voltage range and a maximum transfer current for the charging pile 10A
4-06 create a multi-pile charging plan from the sets of parameters received from each of the charging piles 10A, the starting power storage and target storage of the battery 15, and a set of safety limits for the vehicle electrical system
4-07 after review, authorized the multi-pile charging plan and commence the charging stage for each charging pile 10A, each charging pile 10A conducting an independent charging session
4-08 commence a shutdown stage for each independent charging session and disconnect umbilical lines 10G

A first embodiment of the invention is a system for vehicle-side control of a multi-pile charging session, the system comprising: (a) a plurality of charging piles 10A; and (b) a vehicle electrical system for an electric vehicle. Each charging pile 10A comprises: (i) a power line 10H electrically connected to a power connector 10D at a first end and to a charging connector 10F at a second end; and (ii) a supply equipment communication controller (SECC) 10B. The power line 10H is connectable to a utility line (UL₀, UL₁, UL₂). The power line 10H includes a relay switch 10C positioned between the power connector 10D and the charging connector 10F. A charging pile power line communication module (CP-PLC) 10E is positioned adjacent the power line 10H between the relay switch 10C and the charging connector 10F. The SECC 10B is in data communication with the relay switch 10C and the CP-PLC 10E. Current is permitted to flow from the utility line (UL₀, UL₁, UL₂) to the charging connector 10F through the power line 10H, upon activation of the relay switch 10C by the SECC 10B. The vehicle electrical system includes: (i) a battery 15 including a plurality of battery management units (BMUs) 15A and a plurality of battery cells 15C; (ii) a busbar relay 16 in electrical connection to the battery cells 15C via at least one busbar battery trunk 16A; (iii) a plurality of charging ports (CP₀, CP₁, CP₂); (iv) a plurality of busbar input trunks (BIT₀, BIT₁, BIT₂); and (v) a master battery control unit (MBCU) 18. Each charging port (CP₀, CP₁, CP₂) is configured for electrical connection to the charging connector 10F of one of the charging piles 10A. The charging port (CP₀, CP₁, CP₂) is directly electrically connected to the charging connector 10F or the charging port (CP₀, CP₁, CP₂) is indirectly electrically connected to the charging connector 10F through an umbilical line 10G. Each busbar input trunk (BIT₀, BIT₁, BIT₂) is electrically connected to one of the charging ports (CP₀, CP₁, CP₂) at a first junction and to the busbar relay 16 at a second junction. Each busbar input trunk (BIT₀, BIT₁, BIT₂) is in data communication with an electric vehicle power line communication module (EV-PLC) (PLC₀, PLC₁, PLC₂) positioned adjacent the busbar input trunk (BIT₀, BIT₁, BIT₂) between the charging port (CP₀, CP₁, CP₂) associated with the busbar input trunk (BIT₀, BIT₁, BIT₂) and the busbar relay 16. The MBCU 18 is in data communication with a plurality of battery control units (BCU) (BCU₀, BCU₁, BCU₂), the BMUs 15A of the battery 15, the busbar relay 16, and a user interface device 17. Each BCU (BCU₀, BCU₁, BCU₂) is paired in data communication with one of the EV-PLCs (PLC₀, PLC₁, PLC₂) to establish a BCU-to-SECC communication pathway 22 for the BCU (BCU₀, BCU₁, BCU₂) upon a connective pairing of the charging port (CP₀, CP₁, CP₂) associated with the BCU (BCU₀, BCU₁, BCU₂) and one of the charging connectors 10F. The BCU-to-SECC communication pathway 22 for each BCU (BCU₀, BCU₁, BCU₂) passes from the BCU (BCU₀, BCU₁, BCU₂) to the EV-PLC (PLC₀, PLC₁, PLC₂) associated with the BCU (BCU₀, BCU₁, BCU₂), to the busbar input trunk (BIT₀, BIT₁, BIT₂) associated with the EV-PLC (PLC₀, PLC₁, PLC₂), to the connectively paired charging port (CP₀, CP₁, CP₂) associated with the busbar input trunk (BIT₀, BIT₁, BIT₂), to the connectively paired charging connector 10F associated with the connectively paired charging port (CP₀, CP₁, CP₂), to the power line 10H associated with the connectively paired charging connector 10F, to the CP-PLC 10E associated with the power line 10H, and to the SECC 10B associated with the CP-PLC 10E. The MBCU 18 is configured to: (a) coordinate two or more independent charging sessions during each multi-pile charging session to charge the battery cells 15C simultaneously through two or more charging ports (CP₀, CP₁, CP₂) according to a multi-pile charging plan; and (b) manage each independent charging session with an independent protocol message exchange through each BCU-to-SECC communication pathway 22, from the BCU (BCU₀, BCU₁, BCU₂) of the BCU-to-SECC communication pathway 22 to the SECC 10B of the BCU-to-SECC communication pathway 22. Each independent charging session includes an initiation stage, a charging stage, and a shutdown stage conducted through the associated BCU-to-SECC communication pathway 22.

While not illustrated in FIGS. 1 and 2, sensor information from the battery sensors 15B can be collected by the BMUs 15A.

A second embodiment of the invention is a computer-implemented method for vehicle-side control of a multi-pile charging session, the method comprising the steps of: (a) maintaining a plurality of charging piles 10A; (b) maintaining a vehicle electrical system for an electric vehicle; (c) coordinating with the MBCU 18 two or more independent charging sessions during each multi-pile charging session to charge the battery cells 15C simultaneously through two or more charging ports (CP₀, CP₁, CP₂) according to a multi-pile charging plan; and (d) managing with the MBCU 18 each independent charging session with an independent protocol message exchange through each BCU-to-SECC communication pathway 22, from the BCU (BCU₀, BCU₁, BCU₂) of the BCU-to-SECC communication pathway 22 to the SECC of the BCU-to-SECC communication pathway 22, wherein each independent charging session includes an initiation stage, a charging stage, and a shutdown stage conducted through the associated BCU-to-SECC communication pathway 22. Each charging pile 10A includes: (i) a power line 10H electrically connected to a power connector 10D at a first end and to a charging connector 10F at a second end; and (ii) a supply equipment communication controller (SECC) 10B. The power line 10H is connectable to a utility line (UL₀, UL₁, UL₂). The power line 10H includes a relay switch 10C positioned between the power connector 10D and the charging connector 10F. A charging pile power line communication module (CP-PLC) 10E is positioned adjacent the power line 10H between the relay switch 10C and the charging connector 10F. The SECC 10B is in data communication with the relay switch 10C and the CP-PLC 10E. Current is permitted to flow from the utility line (UL₀, UL₁, UL₂) to the charging connector 10F through the power line 10H, upon activation of the relay switch 10C by the SECC 10B. The vehicle electrical system includes: (i) a battery 15 including a plurality of battery management units (BMUs) 15A and a plurality of battery cells 15C; and (ii) a busbar relay 16 in electrical connection to the battery cells 15C via at least one busbar battery trunk 16A; (iii) a plurality of charging ports (CP₀, CP₁, CP₂); (iv) a plurality of busbar input trunks (BIT₀, BIT₁, BIT₂); and (v) a master battery control unit (MBCU) 18. Each charging port (CP₀, CP₁, CP₂) is configured for electrical connection to the charging connector 10F of one of the charging piles 10A. The charging port (CP₀, CP₁, CP₂) is directly electrically connected to the charging connector 10F or the charging port (CP₀, CP₁, CP₂) is indirectly electrically connected to the charging connector 10F through an umbilical line 10G. Each busbar input trunk (BIT₀, BIT₁, BIT₂) is electrically connected to one of the charging ports (CP₀, CP₁, CP₂) at a first junction and to the busbar relay 16 at a second junction. Each busbar input trunk (BIT₀, BIT₁, BIT₂) is in data communication with an electric vehicle power line communication module (EV-PLC) (PLC₀, PLC₁, PLC₂) positioned adjacent the busbar input trunk (BIT₀, BIT₁, BIT₂) between the charging port (CP₀, CP₁, CP₂) associated with the busbar input trunk (BIT₀, BIT₁, BIT₂) and the busbar relay 16. The MBCU 18 is in data communication with a plurality of battery control units (BCU) (BCU₀, BCU₁, BCU₂), the BMUs 15A of the battery 15, the busbar relay 16, and a user interface device 17. Each BCU (BCU₀, BCU₁, BCU₂) is paired in data communication with one of the EV-PLCs (PLC₀, PLC₁, PLC₂) to establish a BCU-to-SECC communication pathway 22 for the BCU (BCU₀, BCU₁, BCU₂) upon a connective pairing of the charging port (CP₀, CP₁, CP₂) associated with the BCU (BCU₀, BCU₁, BCU₂) and one of the charging connectors 10F. The BCU-to-SECC communication pathway 22 for each BCU (BCU₀, BCU₁, BCU₂) passes from the BCU (BCU₀, BCU₁, BCU₂) to the EV-PLC (PLC₀, PLC₁, PLC₂) associated with the BCU (BCU₀, BCU₁, BCU₂), to the busbar input trunk (BIT₀, BIT₁, BIT₂) associated with the EV-PLC (PLC₀, PLC₁, PLC₂), to the connectively paired charging port (CP₀, CP₁, CP₂) associated with the busbar input trunk (BIT₀, BIT₁, BIT₂), to the connectively paired charging connector 10F associated with the connectively paired charging port (CP₀, CP₁, CP₂), to the power line 10H associated with the connectively paired charging connector 10F, to the CP-PLC 10E associated with the power line 10H, and to the SECC 10B associated with the CP-PLC 10E.

While not illustrated in FIGS. 1 and 2, sensor information from the battery sensors 15B can be collected by the BMUs 15A.

In an alternate embodiment of the first and second embodiment, the user interface device 17 is integrated into a vehicle control unit of the electric vehicle. The vehicle control unit would of a ferry 14, for instance, would typically be on the bridge of the ferry 14.

In an alternate embodiment of the first and second embodiment, the multi-pile charging session is conducted without any data communication between the charging piles 10A utilized in the multi-pile charging session.

This alternate embodiment clarifies that a multi-pile charging session can, for instance, be implemented using charging piles 10A from different charging substations 10. The multi-pile charging session can also be conducting using independent charging sessions authorized by separate vendors via communication with separate servers 13.

In an alternate embodiment of the first and second embodiment: (a) wherein the MBCU 18 is in data communication with the BMUs 15A via one of the BCUs 15A; (b) wherein during the initiation stage, the MBCU 18 or the user interface device 17 conducts an initial safety check from sensor information received by the MBCU 18 from the BMUs 15A and a plurality of busbar sensors; and (c) during the charging stage, the MBCU 18 or the user interface device 17 conducts an ongoing safety assessment from the sensor information received by the MBCU 18 from the BMUs 15A and the busbar sensors. In this alternative embodiment, the busbar sensors can alternatively also include at least one of: (a) an insulation detection sensor; (b) a current meter; and (c) a temperature sensor.

Using the MBCU 18 to both manage the multi-pile charging session and the critical sensors used for safety checks/assessment provides the capability of a faster response to emerging safety issues. E.g., the MBCU 18 has data communication both with each of the charging piles 10A through the BCUs (BCU₀, BCU₁, BCU₂) as well as access to important sensors in the battery 15 and busbar relay 16, thus the MBCU 18 is well-positioned to initiate emergency shut-down of any independent charging session should the need arise.

In an alternate embodiment of the first and second embodiment with a server 13, the embodiment further includes or maintains a server 13 in data communication with the SECC 10B of each charging pile 10A through a network 12, the server 13 including a database comprising a plurality of vehicle records and a plurality of meter records. Each vehicle record includes, for each of a plurality of vehicles, a vehicle identifier and an account status. Each meter record identifies at least one vehicle identifier and a charging session summary for each multi-pile charging session.

In a first alternate embodiment of the first and second embodiment with a server 13, the embodiment further includes or maintains a server 13 in data communication with the SECC 10B of each charging pile 10A through a network 12, the server 13 including a database comprising a plurality of vehicle records and a plurality of meter records. Each vehicle record includes, for each of a plurality of vehicles, a vehicle identifier and an account status. Each meter record identifies at least one vehicle identifier and a charging session summary for each multi-pile charging session. During the initiation stage of each independent charging session, the independent protocol message exchange conducted through the BCU-to-SECC communication pathway 22 can alternatively include: (a) delivery of the vehicle identifier of the electric vehicle from the BCU (BCU₀, BCU₁, BCU₂) to the SECC 10B; (b) return delivery of the authorization approval of the independent charging session from the SECC 10B to the BCU (BCU₀, BCU₁, BCU₂); and (c) delivery of a set of parameters for the charging pile 10A associated with the BCU-to-SECC communication pathway 22, each set of parameters including an output voltage range and a maximum transfer current. The SECC 10B forwards the vehicle identifier to the server 13 with an authorization request for the independent charging session. The server 13 accesses the account status of the vehicle record associated with the vehicle identifier to, if so authorized, issue an authorization approval for the independent charging session. The server 13 return delivers the authorization approval to the SECC 10B.

In a second alternate embodiment of the first and second embodiment with a server 13, the embodiment further includes or maintains a server 13 in data communication with the SECC 10B of each charging pile 10A through a network 12, the server 13 including a database comprising a plurality of vehicle records and a plurality of meter records. Each vehicle record includes, for each of a plurality of vehicles, a vehicle identifier and an account status. Each meter record identifies at least one vehicle identifier and a charging session summary for each multi-pile charging session. During the initiation stage of each independent charging session, the independent protocol message exchange conducted through the BCU-to-SECC communication pathway 22 can alternatively include: (a) delivery of the vehicle identifier of the electric vehicle from the BCU (BCU₀, BCU₁, BCU₂) to the SECC 10B; (b) return delivery of the authorization approval of the independent charging session from the SECC 10B to the BCU (BCU₀, BCU₁, BCU₂); and (c) delivery of a set of parameters for the charging pile 10A associated with the BCU-to-SECC communication pathway 22, each set of parameters including an output voltage range and a maximum transfer current. The SECC 10B forwards the vehicle identifier to the server 13 with an authorization request for the independent charging session. The server 13 accesses the account status of the vehicle record associated with the vehicle identifier to, if so authorized, issue an authorization approval for the independent charging session. The server 13 return delivers the authorization approval to the SECC 10B. The independent protocol message exchange conducted through the BCU-to-SECC communication pathway 22 during the initiation stage further includes the delivery of a charging port (CP₀, CP₁, CP₂) identifier for the BCU-to-SECC communication pathway 22. Each vehicle record in the database further includes two or more charging port identifiers for the electric vehicle. The charging session summary for each multi-pile charging session includes a listing of the charging port identifiers for the charging piles 10A utilized in the multi-pile charging session.

Especially for multi-port charging sessions, it is valuable to maintain records of which charging port (CP₀, CP₁, CP₂) is employed in additional to use of the vehicle identifier. This bill-keeping approach provides clarity that multiple invoice line items are related to a single multi-pile charging session. Also, if the event of excess charges related to an independent charging session using a specific charging port (CP₀, CP₁, CP₂), the electric vehicle owner can investigate the data communication logs and/or equipment associated with that charging port (CP₀, CP₁, CP₂).

In a third alternate embodiment of the first and second embodiment with a server 13, the embodiment further includes or maintains a server 13 in data communication with the SECC 10B of each charging pile 10A through a network 12, the server 13 including a database comprising a plurality of vehicle records and a plurality of meter records. Each vehicle record includes, for each of a plurality of vehicles, a vehicle identifier and an account status. Each meter record identifies at least one vehicle identifier and a charging session summary for each multi-pile charging session. During the initiation stage of each independent charging session, the independent protocol message exchange conducted through the BCU-to-SECC communication pathway 22 can alternatively include: (a) delivery of the vehicle identifier of the electric vehicle from the BCU (BCU₀, BCU₁, BCU₂) to the SECC 10B; (b) return delivery of the authorization approval of the independent charging session from the SECC 10B to the BCU (BCU₀, BCU₁, BCU₂); and (c) delivery of a set of parameters for the charging pile 10A associated with the BCU-to-SECC communication pathway 22, each set of parameters including an output voltage range and a maximum transfer current. The SECC 10B forwards the vehicle identifier to the server 13 with an authorization request for the independent charging session. The server 13 accesses the account status of the vehicle record associated with the vehicle identifier to, if so authorized, issue an authorization approval for the independent charging session. The server 13 return delivers the authorization approval to the SECC 10B. The user interface device 17 is in data communication with the server 13 through the network 12. The user interface device is configured to assemble the multi-pile charging plan from at least one of: (i) a custom charging plan; (ii) a preconfigured charging plan for the charging piles 10A, wherein the preconfigured charging plan is accessible from the server 13 through the user interface device; and (iii) a prior multi-pile charging plan previously successfully performed by the electric vehicle. The custom charging plan is calculated from: (1) the sets of parameters received from the charging piles 10A associated with the BCU-to-SECC communication pathways 22 successfully completing the initiation stage, including the output voltage range and the maximum transfer current for each charging pile 10A; (2) a starting power storage of the battery 15; (3) a target power storage of the battery 15; and (4) a set of safety limits for the vehicle electrical system.

Details from prior multi-pile charging plans can be used in future multi-pile charging sessions to increase power transfer efficiency, increase battery 15 lifespan, reduce equipment failures, and increase safety. Analysis of former multi-pile charging session details can also be used to predict future power expense budgets and potentially improve future designs of the charging substations 10 and vehicle electrical systems.

In a fourth alternate embodiment of the first and second embodiment with a server 13, the embodiment further includes or maintains a server 13 in data communication with the SECC 10B of each charging pile 10A through a network 12, the server 13 including a database comprising a plurality of vehicle records and a plurality of meter records. Each vehicle record includes, for each of a plurality of vehicles, a vehicle identifier and an account status. Each meter record identifies at least one vehicle identifier and a charging session summary for each multi-pile charging session. During the initiation stage of each independent charging session, the independent protocol message exchange conducted through the BCU-to-SECC communication pathway 22 can alternatively include: (a) delivery of the vehicle identifier of the electric vehicle from the BCU (BCU₀, BCU₁, BCU₂) to the SECC 10B; (b) return delivery of the authorization approval of the independent charging session from the SECC 10B to the BCU (BCU₀, BCU₁, BCU₂); and (c) delivery of a set of parameters for the charging pile 10A associated with the BCU-to-SECC communication pathway 22, each set of parameters including an output voltage range and a maximum transfer current. The SECC 10B forwards the vehicle identifier to the server 13 with an authorization request for the independent charging session. The server 13 accesses the account status of the vehicle record associated with the vehicle identifier to, if so authorized, issue an authorization approval for the independent charging session. The server 13 return delivers the authorization approval to the SECC 10B. The user interface device is in data communication with the server 13 through the network 12. The user interface device is configured to assemble the multi-pile charging plan from at least one of: (i) a custom charging plan; (ii) a preconfigured charging plan for the charging piles 10A, wherein the preconfigured charging plan is accessible from the server 13 through the user interface device; and (iii) a prior multi-pile charging plan previously successfully performed by the electric vehicle. The custom charging plan is calculated from: (1) the sets of parameters received from the charging piles 10A associated with the BCU-to-SECC communication pathways 22 successfully completing the initiation stage, including the output voltage range and the maximum transfer current for each charging pile 10A; (2) a starting power storage of the battery 15; (3) a target power storage of the battery 15; and (4) a set of safety limits for the vehicle electrical system. A safety simulation of the multi-pile charging plan is conducted by the user interface device or the server 13 prior to the charging stage. Each multi-pile charging plan includes an emergency shutdown protocol. Commencement of the charging stage requires prior review and authorization through the user interface device of the multi-pile charging plan by an authenticated user of the electric vehicle. The user interface device or the server 13 stores a sensor information log for each multi-pile charging session.

The authorization approval could be established, for instance, by requiring a login and password of the ferry captain or other trained officer of the ferry 14 to ensure proper compliance with billing and/or safety procedures of the ferry 14. AI/ML can be used to improve future multi-pile charging plans by analysing sensor log details from electric vehicles during previous multi-pile charging sessions.

While various aspects and embodiments have been disclosed herein, it will be apparent that various other modifications and adaptations of the invention will be apparent to the person skilled in the art after reading the foregoing disclosure without departing from the spirit and scope of the invention and it is intended that all such modifications and adaptations come within the scope of the appended claims. The various aspects and embodiments disclosed herein are for purposes of illustration and are not intended to be limiting, with the true scope and spirit of the invention being indicated by the appended claims.

1. A system for vehicle-side control of a multi-pile charging session, the system comprising:
(a) a plurality of charging piles, each charging pile comprising:
(i) a power line electrically connected to a power connector at a first end and to a charging connector at a second end,
(1) wherein the power line is connectable to a utility line;
(2) wherein the power line includes a relay switch positioned between the power connector and the charging connector; and
(3) wherein a charging pile power line communication module (CP-PLC) is positioned adjacent the power line between the relay switch and the charging connector;
(ii) a supply equipment communication controller (SECC),
(1) wherein the SECC is in data communication with the relay switch and the CP-PLC; and
(2) wherein current is permitted to flow from the utility line to the charging connector through the power line, upon activation of the relay switch by the SECC; and
(b) a vehicle electrical system for an electric vehicle including:
(i) a battery including a plurality of battery management units (BMUs), and a plurality of battery cells;
(ii) a busbar relay in electrical connection to the battery cells via at least one busbar battery trunk;
(iii) a plurality of charging ports,
(1) wherein each charging port is configured for electrical connection to the charging connector of one of the charging piles; and
(2) wherein the charging port is directly electrically connected to the charging connector or the charging port is indirectly electrically connected to the charging connector through an umbilical line;
(iv) a plurality of busbar input trunks,
(1) wherein each busbar input trunk is electrically connected to one of the charging ports at a first junction and to the busbar relay at a second junction; and
(2) wherein each busbar input trunk is in data communication with an electric vehicle power line communication module (EV-PLC) positioned adjacent the busbar input trunk between the charging port associated with the busbar input trunk and the busbar relay; and
(v) a master battery control unit (MBCU),
(1) wherein the MBCU is in data communication with a plurality of battery control units (BCU), the BMUs of the battery, the busbar relay, and a user interface device;
(2) wherein each BCU is paired in data communication with one of the EV-PLCs to establish a BCU-to-SECC communication pathway for the BCU upon a connective pairing of the charging port associated with the BCU and one of the charging connectors;
(3) wherein the BCU-to-SECC communication pathway for each BCU passes from the BCU to the EV-PLC associated with the BCU, to the busbar input trunk associated with the EV-PLC, to the connectively paired charging port associated with the busbar input trunk, to the connectively paired charging connector associated with the connectively paired charging port, to the power line associated with the connectively paired charging connector, to the CP-PLC associated with the power line, and to the SECC associated with the CP-PLC; and
(4) wherein the MBCU is configured to:
(a) coordinate two or more independent charging sessions during each multi-pile charging session to charge the battery cells simultaneously through two or more charging ports according to a multi-pile charging plan; and
(b) manage each independent charging session with an independent protocol message exchange through each BCU-to-SECC communication pathway, from the BCU of the BCU-to-SECC communication pathway to the SECC of the BCU-to-SECC communication pathway, wherein each independent charging session includes an initiation stage, a charging stage, and a shutdown stage conducted through the associated BCU-to-SECC communication pathway.

2. The system of claim 1, wherein the user interface device is integrated into a vehicle control unit of the electric vehicle.

3. The system of claim 1, wherein the multi-pile charging session is conducted without any data communication between the charging piles utilized in the multi-pile charging session.

4. The system of claim 1,
(a) wherein the MBCU is in data communication with the BMUs via one of the BCUs;
(b) wherein during the initiation stage, the MBCU or the user interface device conducts an initial safety check from sensor information received by the MBCU from the BMUs and a plurality of busbar sensors; and
(c) wherein during the charging stage, the MBCU or the user interface device conducts an ongoing safety assessment from the sensor information received by the MBCU from the BMUs and the busbar sensors.

5. The system of claim 4, wherein the busbar sensors include at least one of:
(a) an insulation detection sensor;
(b) a current meter; and
(c) a temperature sensor.

6. The system of claim 1, further comprising a server in data communication with the SECC of each charging pile through a network, the server including a database comprising a plurality of vehicle records and a plurality of meter records,
(a) wherein each vehicle record includes, for each of a plurality of vehicles, a vehicle identifier and an account status; and
(b) wherein each meter record identifies at least one vehicle identifier and a charging session summary for each multi-pile charging session.

7. The system of claim 6, wherein during the initiation stage of each independent charging session, the independent protocol message exchange conducted through the BCU-to-SECC communication pathway includes:
(a) delivery of the vehicle identifier of the electric vehicle from the BCU to the SECC,
(i) wherein the SECC forwards the vehicle identifier to the server with an authorization request for the independent charging session;
(ii) wherein the server accesses the account status of the vehicle record associated with the vehicle identifier to, if so authorized, issue an authorization approval for the independent charging session; and
(iii) wherein the server return delivers the authorization approval to the SECC;
(b) return delivery of the authorization approval of the independent charging session from the SECC to the BCU; and
(c) delivery of a set of parameters for the charging pile associated with the BCU-to-SECC communication pathway, each set of parameters including an output voltage range and a maximum transfer current.

8. The system of claim 7,
(a) wherein the independent protocol message exchange conducted through the BCU-to-SECC communication pathway during the initiation stage further includes the delivery of a charging port identifier for the BCU-to-SECC communication pathway;
(b) wherein each vehicle record in the database further includes two or more charging port identifiers for the electric vehicle; and
(c) wherein the charging session summary for each multi-pile charging session includes a listing of the charging port identifiers for the charging piles utilized in the multi-pile charging session.

9. The system of claim 7,
(a) wherein the user interface device is in data communication with the server through the network; and
(b) wherein the user interface device is configured to assemble the multi-pile charging plan from at least one of:
(i) a custom charging plan calculated from:
(1) the sets of parameters received from the charging piles associated with the BCU-to-SECC communication pathways successfully completing the initiation stage, including the output voltage range and the maximum transfer current for each charging pile;
(2) a starting power storage of the battery;
(3) a target power storage of the battery; and
(4) a set of safety limits for the vehicle electrical system;
(ii) a preconfigured charging plan for the charging piles, wherein the preconfigured charging plan is accessible from the server through the user interface device; and
(iii) a prior multi-pile charging plan previously successfully performed by the electric vehicle.

10. The system of claim 9,
(a) wherein a safety simulation of the multi-pile charging plan is conducted by the user interface device or the server prior to the charging stage;
(b) wherein each multi-pile charging plan includes an emergency shutdown protocol;
(c) wherein commencement of the charging stage requires prior review and authorization through the user interface device of the multi-pile charging plan by an authenticated user of the electric vehicle; and
(d) wherein the user interface device or the server stores a sensor information log for each multi-pile charging session.

11. A computer-implemented method for vehicle-side control of a multi-pile charging session, the method comprising the steps of:
(a) maintaining a plurality of charging piles, each charging pile comprising:
(i) a power line electrically connected to a power connector at a first end and to a charging connector at a second end,
(1) wherein the power line is connectable to a utility line;
(2) wherein the power line includes a relay switch positioned between the power connector and the charging connector; and
(3) wherein a charging pile power line communication module (CP-PLC) is positioned adjacent the power line between the relay switch and the charging connector; and
(ii) a supply equipment communication controller (SECC),
(1) wherein the SECC is in data communication with the relay switch and the CP-PLC; and
(2) wherein current is permitted to flow from the utility line to the charging connector through the power line, upon activation of the relay switch by the SECC;
(b) maintaining a vehicle electrical system for an electric vehicle including:
(i) a battery including a plurality of battery management units (BMUs), and a plurality of battery cells;
(ii) a busbar relay in electrical connection to the battery cells via at least one busbar battery trunk;
(iii) a plurality of charging ports,
(1) wherein each charging port is configured for electrical connection to the charging connector of one of the charging piles; and
(2) wherein the charging port is directly electrically connected to the charging connector or the charging port is indirectly electrically connected to the charging connector through an umbilical line;
(iv) a plurality of busbar input trunks,
(1) wherein each busbar input trunk is electrically connected to one of the charging ports at a first junction and to the busbar relay at a second junction; and
(2) wherein each busbar input trunk is in data communication with an electric vehicle power line communication module (EV-PLC) positioned adjacent the busbar input trunk between the charging port associated with the busbar input trunk and the busbar relay; and
(v) a master battery control unit (MBCU),
(1) wherein the MBCU is in data communication with a plurality of battery control units (BCU), the BMUs of the battery, the busbar relay, and a user interface device;
(2) wherein each BCU is paired in data communication with one of the EV-PLCs to establish a BCU-to-SECC communication pathway for the BCU upon a connective pairing of the charging port associated with the BCU and one of the charging connectors; and
(3) wherein the BCU-to-SECC communication pathway for each BCU passes from the BCU to the EV-PLC associated with the BCU, to the busbar input trunk associated with the EV-PLC, to the connectively paired charging port associated with the busbar input trunk, to the connectively paired charging connector associated with the connectively paired charging port, to the power line associated with the connectively paired charging connector, to the CP-PLC associated with the power line, and to the SECC associated with the CP-PLC;
(c) coordinating with the MBCU two or more independent charging sessions during each multi-pile charging session to charge the battery cells simultaneously through two or more charging ports according to a multi-pile charging plan; and
(d) managing with the MBCU each independent charging session with an independent protocol message exchange through each BCU-to-SECC communication pathway, from the BCU of the BCU-to-SECC communication pathway to the SECC of the BCU-to-SECC communication pathway, wherein each independent charging session includes an initiation stage, a charging stage, and a shutdown stage conducted through the associated BCU-to-SECC communication pathway.

12. The method of claim 11, wherein the user interface device is integrated into a vehicle control unit of the electric vehicle.

13. The method of claim 11, wherein the multi-pile charging session is conducted without any data communication between the charging piles utilized in the multi-pile charging session.

14. The method of claim 11,
(a) wherein the MBCU is in data communication with the BMUs via one of the BCUs;
(b) wherein during the initiation stage, the MBCU or the user interface device conducts an initial safety check from sensor information received by the MBCU from the BMUs and a plurality of busbar sensors; and
(c) wherein during the charging stage, the MBCU or the user interface device conducts an ongoing safety assessment from the sensor information received by the MBCU from the BMUs and the busbar sensors.

15. The method of claim 14, wherein the busbar sensors include at least one of:
(a) an insulation detection sensor;
(b) a current meter; and
(c) a temperature sensor.

16. The method of claim 11, further comprising maintaining a server in data communication with the SECC of each charging pile through a network, the server including a database comprising a plurality of vehicle records and a plurality of meter records,
(a) wherein each vehicle record includes, for each of a plurality of vehicles, a vehicle identifier and an account status; and
(b) wherein each meter record identifies at least one vehicle identifier and a charging session summary for each multi-pile charging session.

17. The method of claim 16, wherein during the initiation stage of each independent charging session, the independent protocol message exchange conducted through the BCU-to-SECC communication pathway includes:
(a) delivery of the vehicle identifier of the electric vehicle from the BCU to the SECC,
(i) wherein the SECC forwards the vehicle identifier to the server with an authorization request for the independent charging session;
(ii) wherein the server accesses the account status of the vehicle record associated with the vehicle identifier to, if so authorized, issue an authorization approval for the independent charging session; and
(iii) wherein the server return delivers the authorization approval to the SECC;
(b) return delivery of the authorization approval of the independent charging session from the SECC to the BCU; and
(c) delivery of a set of parameters for the charging pile associated with the BCU-to-SECC communication pathway, each set of parameters including an output voltage range and a maximum transfer current.

18. The method of claim 17,
(a) wherein the independent protocol message exchange conducted through the BCU-to-SECC communication pathway during the initiation stage further includes the delivery of a charging port identifier for the BCU-to-SECC communication pathway;
(b) wherein each vehicle record in the database further includes two or more charging port identifiers for the electric vehicle; and
(c) wherein the charging session summary for each multi-pile charging session includes a listing of the charging port identifiers for the charging piles utilized in the multi-pile charging session.

19. The method of claim 17,
(a) wherein the user interface device is in data communication with the server through the network; and
(b) wherein the user interface device is configured to assemble the multi-pile charging plan from at least one of:
(i) a custom charging plan calculated from:
(1) the sets of parameters received from the charging piles associated with the BCU-to-SECC communication pathways successfully completing the initiation stage, including the output voltage range and the maximum transfer current for each charging pile;
(2) a starting power storage of the battery;
(3) a target power storage of the battery; and
(4) a set of safety limits for the vehicle electrical system;
(ii) a preconfigured charging plan for the charging piles, wherein the preconfigured charging plan is accessible from the server through the user interface device; and
(iii) a prior multi-pile charging plan previously successfully performed by the electric vehicle.

20. The method of claim 19,
(a) wherein a safety simulation of the multi-pile charging plan is conducted by the user interface device or the server prior to the charging stage;
(b) wherein each multi-pile charging plan includes an emergency shutdown protocol;
(c) wherein commencement of the charging stage requires prior review and authorization through the user interface device of the multi-pile charging plan by an authenticated user of the electric vehicle; and
(d) wherein the user interface device or the server stores a sensor information log for each multi-pile charging session.
